(19) United States
(12) Patent Application Publication
(10) Pub. No.: US 2010/0186975 A1
(43) Pub. Date: Jul. 29, 2010

(54) ELECTRIC TOOL HAVING COLD START FUNCTION

(76) Inventor: Rainer Glauning, Aichtal-Groetzingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/665,605

(22) PCT Filed: Apr. 23, 2008
(86) PCT No.: PCT/EP2008/054886

§ 371 Date: Dec. 18, 2009

(30) Foreign Application Priority Data
Jun. 18, 2007 (DE) 102007027898.7

(51) Int. Cl. B25F 5/00; H02P 1/02

(52) U.S. Cl. 173/1; 173/217; 173/20

(57) ABSTRACT

The effectiveness with which an electric tool having a rechargeable battery can be operated is dependant on the temperature prevailing in the electric tool. In order to increase the operation of the electric tool at low temperatures, a cold start function that can be activated is provided in the electric tool.

The invention relates to an electric tool having a tool switch and a rechargeable battery. The invention furthermore relates to a method for cold starting an electric tool that has a tool switch and a rechargeable battery.

Electric tools that can be operated with a rechargeable battery are known in manifold uses, for instance as power drills, cordless screwdrivers, garden cutting tools, or the like. As described for instance in German Patent Disclosure DE 40 38 786 A1, such electric tools have a tool switch for control and regulation of the tool rpm by the user. Because of their independence from a cord connection, the electric tools can be used in many places, especially outdoors. The effectiveness with which such electric tools can be operated, however, depends on the prevailing ambient temperature, or more precisely on the temperature prevailing in the electric tool. Particularly at low temperatures, the internal resistance of the rechargeable battery pack increases considerably. Among other effects, this means that at low temperatures, the electric tool can be operated only very slowly or does not start up at all. This effect occurs even though an electronics unit is usually provided in the electric tool with which it is assured that the permissible limit values for current, voltage or temperature will not be overshot or undershot. Moreover, even with RDC compensation often implemented in the battery, the described effect cannot be avoided or can be avoided only inadequately.

The difficulties described in the operation of the electric tool can usually be eliminated if the electric tool is made to “warm up” for some time, such as for two minutes; in other words, despite this clearly unsatisfactory operating situation, the user can still operate the tool during that time. Thus warming up of the rechargeable battery pack and of the electric tool is attained, and its full usability is attained. However, the user often fails to do this, because he interprets the very slow operation of the electric tool, or its failure to start up, as a malfunction or complete failure or is damaged and then no longer actuates the tool switch, so that warming up cannot occur.

According to the invention, in an electric tool an activatable cold start arrangement is now provided, with which a warmup of the electric tool is made possible. The cold start arrangement is activated particularly whenever the temperature ascertained at a suitable point in the electric tool by a temperature sensor has undershot a predefined threshold value. To that end, a temperature sensor can be provided, for instance for detecting the temperature of the rechargeable battery pack.

The activation of the cold start arrangement can be made visible to the user via an optical display device, in particular an LED.

In a preferred embodiment of the invention, the activatable cold start arrangement is embodied as a short-circuit current path, with a resistor, in particular a heating resistor. This is especially advantageous if the heating resistor is positioned such that with it the rechargeable battery can be easily warmed up, or in other words when the resistor is positioned in the immediate vicinity of the rechargeable battery, for example. A rapid warmup is thus attained, and with it a shortening of the warmup time.

In a further embodiment of the invention, the cold start arrangement is activated in that the current for warming up the electric tool is guided via the windings of the motor, or in other words that the cold start arrangement is embodied as a warmup current path via the motor. Then no additional heating resistor has to be provided in the electric tool.

If the winding of the motor is used as the warmup current path, it is advantageous to prevent unintentional starting of the motor. For that purpose, a device for mechanically decoupling the motor from the gear during the activation of the cold start arrangement, and in particular an additional clutch, can be provided. It is also possible to ensure unintentional starting of the motor by providing that the motor is blocked for the time of activation of the cold start arrangement. This can be attained mechanically, for instance by means of a bolt, or electronically, for instance by means of a constant or variable, preferably high-frequency repolarization of the motor in clockwise/counterclockwise rotation.

By the method of the invention for cold starting an electric tool having a tool switch and a rechargeable battery, the temperature in the electric tool is detected. As soon as it is found that the detected temperature is below a predetermined threshold temperature, a cold start function is activated in the electric tool.

The activation of the cold start function can be displayed with an optical display device, in particular an LED, and for that purpose a temperature warning LED can for instance be shut off, or a cold start display LED can be switched on. This gives the user important information about the present operating state of the electric tool and its imminent readiness for use.

Preferably, the cold start function is activated by providing that a short-circuit current path with a heating resistor is closed. Simultaneously, the current path to the motor is interrupted. However, if the short-circuit current path is dispensed with, the current can also be guided via the windings of the motor of the electric tool. Preheating is thus attained, and in that case the motor is blocked and/or decoupled from the gear for that period of time.

The temperature is preferably detected at the rechargeable battery, which also makes it possible to regulate the cold start function as a function of the currently measured temperature at the rechargeable battery. In particular, it is then possible for the frequency at which the motor is blocked by repolarization to be varied as a function of the temperature of the rechargeable battery and/or of the current currently furnishable by the rechargeable battery.

Further advantages and advantageous embodiments of the invention are the subject of the ensuing drawings and their descriptions. Individually:

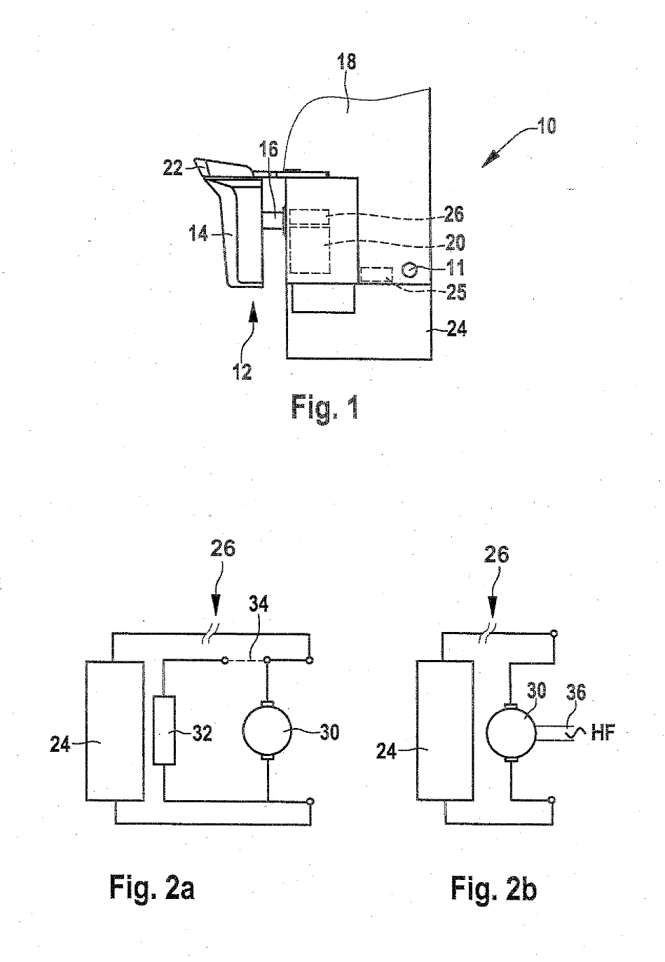

FIG. 1 schematically shows an electric tool with a tool switch and a rechargeable battery;

FIG. 2 shows a circuit diagram with a cold start function; and

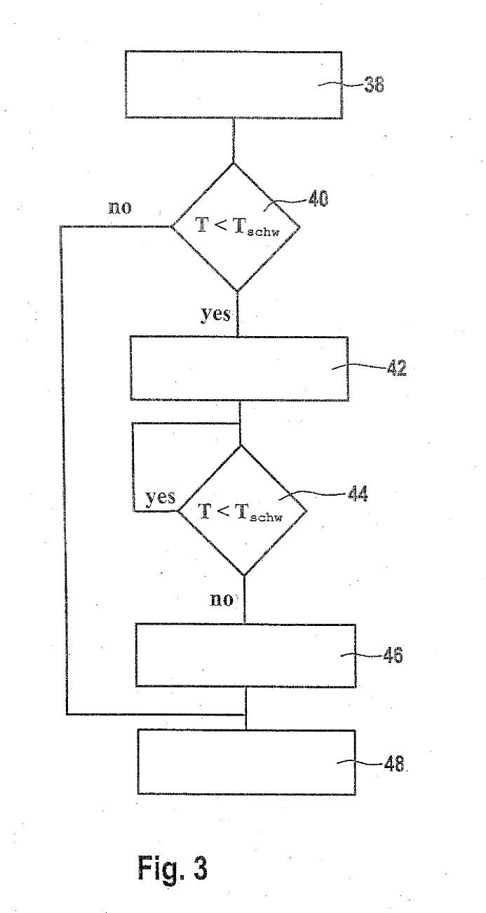

FIG. 3 is a schematic flow chart of a method for cold starting an electric tool.

FIG. 1 schematically shows an electric tool 10, shown in only fragmentary form, having a tool switch 12 and a rechargeable battery pack 24, such as a cordless screwdriver, a cordless power drill, or the like. The tool switch 12 has a push button 14, which is seated on a push button shaft 16 and is connected to an electric tool housing 18. Via the push button 14, a user can manually actuate the electric tool 10 and can for instance vary the rpm. A reversing lever 22 can also be provided for reversing the direction of rotation. With the detachably mounted rechargeable battery 24, the tool switch 12 can be supplied with voltage. Electrical and electronic components are accommodated in the interior of the electric tool housing 18, including a power circuit 20 represented by dashed lines. This power circuit 20 serves to control and regulate the current flowing to the load. Typically, it has a power transistor or a MOSFET. The rechargeable battery pack can have one or more cells, and the rechargeable battery pack is disposed fixedly or detachably in the electric tool.

Also provided in the electric tool 10 is a cold start arrangement 26 for cold starting the electric tool 10. This cold start arrangement 26 makes a warmup of the electric tool 10 possible, if that should be necessary because of the prevailing temperatures. For measuring the temperature, a temperature sensor 25 can be disposed at a suitable point in the interior of the electric tool 10. In particular, the temperature sensor 25 can be positioned on or in the vicinity of the rechargeable battery 24, in such a way that the current rechargeable battery temperature in each case can be detected.

To display the warmup of the electric tool 10 to the user, an LED display 11 may be provided, which upon warmup outputs an optical light signal. The LED signal can be realized in various ways. For instance, an LED can begin to light up as soon as the cold start arrangement 26 is activated. As soon as the cold start arrangement is deactivated again, the LED can cease lighting up. It is also possible to design the LED display such that a temperature warning LED is not extinguished until, after the activation of the cold start arrangement and after the heating up of the rechargeable battery pack, a temperature sufficiently high for operation has been reached. For instance, the activation of the cold start arrangement can take place at a temperature threshold value of −10° C. If the temperature sensor 25, such as an NTC, provided on the rechargeable battery pack, measures a temperature of −20° C., then the cold start arrangement is activated, and a cold start LED begins to light up. In this case, the warmup procedure is stopped whenever a temperature of −10° C. is measured at the rechargeable battery pack. The cold start LED goes out, and the electric tool 10 is ready for operation. Simultaneously, an operational readiness LED can begin to light up, so that the user is always informed of the current operating state of the electric tool. Instead of the LED display 11, which is an optical display, an acoustical display may be provided.

FIG. 2 schematically ically shows circuit diagrams of possible arrangements for realizing a cold start arrangement 26. In FIG. 2a, the cold start arrangement 26 is realized in the form of a short-circuit current path 34.

After the electric tool 10 is switched on, as soon as a suitable temperature sensor 25 finds that the current temperature of the rechargeable battery 24 is below a defined threshold value, such as below −10° C., the short-circuit current path 34 is activated. Thus the current flowing from the rechargeable battery is conducted not via the motor 30 but rather via the short-circuit current path 34 and the resistor 32 located in it.

In a preferred embodiment, the resistor 32 may be embodied as a heating resistor. The resistor 32 is used for warming up the rechargeable battery 24 and is positioned correspondingly close to the rechargeable battery 24, for instance beneath the rechargeable battery pack. As soon as it is found via a temperature sensor that the temperature at the rechargeable battery 24 has risen to above the predefined threshold value, the cold start arrangement is activated, by interrupting the short-circuit current path again, while at the same time the current path to the motor 30 is closed main. The electric tool is then ready for operation again. This prewarming phase typically lasts a few seconds. The operational readiness of the electric tool 10 after the prewarming phase can be recognized on the one hand via the detection of the temperature of the rechargeable battery 24 and on the other also via a measurement of the short-circuit current in the short-circuit current path 34. The time when the short-circuit current rises above a defined threshold value is measured. If this rise has occurred, the rechargeable battery furnishes enough current, and the electric tool 10 can be operated in the normal operating mode.

In a further preferred embodiment, the short-circuit current can also be lowered, or limited to permissible or desired values, as the currently measured temperature increases, so that on the one hand gentle warming is done, and on the other, a lesser load is put on the rechargeable battery 24. For instance, current values to which the short-circuit current is fixed can be specified for fixed temperatures.

To make it possible to realize the cold start arrangement shown, the electric tool is accordingly expanded by a separate activatable short-circuit current path 34 for the warmup. With the circuit arrangements typically provided in such electric tools, it must furthermore be assured that the minimum voltage of the rechargeable battery 24 will not be undershot.

In FIG. 2b, a further version of a cold start arrangement 26 is schematically shown. The cold start arrangement comprises the fact that the current for the prewanning runs directly via the motor 30. However, it must be assured that the motor 30 will not start up. In this case, the cold start arrangement comprises a circuit arrangement, which after the detection by the temperature sensor 25 of a temperature T that is below a predetermined threshold value T_{schw}, assures not only current guidance via the motor 30 but also the blocking and/or decoupling from the gear of the motor. This can be effected on the one hand mechanically, by blocking the motor, for instance by means of a movable blocking bolt, or by means of a defined disengagement from the gear by the use of a separate clutch.

The blocking of the motor 30 can also be accomplished electronically. To that end, the motor 30 is subjected to a high-frequency alternating voltage 36 for high-frequency reversal of the clockwise/counterclockwise rotation. This assures that with the constant and sufficiently high-frequency reversal of the direction of operation of the electric tool 10, a stoppage for the period of activation of the cold start arrangement can be assured.

The interruption points shown schematically in FIGS. 2a and 2b indicate that it is understood that still other electric and electronic components that are typically employed in such electric tools may be present in the circuit.

In FIG. 3, the flow of the method of the invention for cold starting an electric tool is shown schematically. To that end, after the electric tool is switched on, the current rechargeable battery temperature T is measured by a temperature sensor 25 in step 38.

In step 40, it is ascertained whether this temperature is below a predetermined temperature threshold value T_{schw}. For electric tools with lithium-ion rechargeable batteries 24, this threshold value may for instance be −10° C. If the temperature is not below that, then the electric tool 10 can be started immediately in the normal operating mode 48.

If it is found in step 40 that the currently measured temperature T is below the defined threshold T_{schw}, then in step 42, a suitable cold start arrangement is activated. The cold start arrangement may, as already described, for instance comprise the activation of a short-circuit current path or the activation of a heating current through the motor with simultaneous locking or uncoupling of the motor.

Next, in a loop, in step 44 the current temperature T is compared with the threshold temperature T_{schw} until such time as T is above T_{schw}. Then, in step 46, the cold start arrangement is deactivated again, so that the electric tool can then be operated in the normal mode.

According to the invention, the hardware used in the electric tool is supplemented with a cold start arrangement that is activatable when a temperature below a threshold value is detected. The software used in the electric tool 10 is also expanded for controlling the electric tool 10, for activating the cold start arrangement under predetermined temperature conditions and deactivating it again after the warmup. It can thus be attained that in particular the lithium-ion rechargeable batteries used at present will be quickly ready for use even at low temperatures, especially at temperatures of −20° C. or below, and the user will not assume that the equipment is defective. With the same technology of rechargeable battery cells, the range of uses use of electric tools operated with a rechargeable battery, in particular cordless screwdrivers, cordless drills or garden tools can be expanded. The range of use can also be expanded to still other objects that are operated with a rechargeable battery.

1-19. (canceled)

20. An electric tool, comprising
a tool switch;
a rechargeable battery; and
an activatable cold start mechanism.

21. The electric tool as defined by claim 20, further comprising a temperature sensor which detects the temperature of the rechargeable battery.

22. The electric tool as defined by claim 20, further comprising an optical display device, in particular an LED, is provided for displaying an activation of the cold start mechanism.

23. The electric tool as defined by claim 21, further comprising an optical display device, in particular an LED, is provided for displaying an activation of the cold start mechanism.

24. The electric tool as defined by claim 20, wherein the activatable cold start mechanism is embodied as a short-circuit current path having a resistor.

25. The electric tool as defined by claim 24, wherein the short-circuit current path is guided in a vicinity of the rechargeable battery in such a way that the resistor is usable for warming up the rechargeable battery.

26. The electric tool as defined by claim 20, wherein the cold start mechanism is embodied as a warmup current path via the motor.

27. The electric tool as defined by claim 26, further comprising a device for mechanically decoupling the motor from powering the tool during a time of activation of the cold start mechanism.

28. The electric tool as defined by claim 27, wherein the device for mechanically decoupling the motor is embodied as a clutch.

29. The electric tool as defined by claim 26, further comprising a device for blocking the motor during a time of activation of the cold start mechanism.

30. The electric tool as defined by claim 29, wherein the device for blocking the motor is embodied as a mechanical fixation or as an electric high-frequency repolarization of the motor.

31. The electric tool as defined by claim 30, wherein for the device for blocking is a bolt.

32. A method for cold starting an electric tool having a tool switch and a rechargeable battery, comprising the steps of:
detecting a temperature in the electric tool;
comparing the temperature detected in the electric tool with a threshold temperature; and
activating a cold start function if the temperature detected is below the threshold temperature.

33. The method as defined by claim 32, further comprising the step of displaying the activation of the cold start function by an acoustical or optical display device, in particular an LED.

34. The method as defined by claim 32, wherein during the cold start function, a short-circuit current path with a heating resistor is activated.

35. The method as defined by claim 32, wherein during the cold start function, current is guided via the motor of the electric tool, and the motor blocked and/or decoupled from powering the tool.

36. The method as defined by claim 35, wherein the motor is blocked by repolarizing the motor at a constant or variable frequency in clockwise/counterclockwise rotation.

37. The method as defined by claim 36, wherein the repolarizing of the motor is effected at a frequency high enough that the motor does not start.

38. The method as defined by claim 36, wherein the temperature is detected at the rechargeable battery, and the frequency is varied as a function of a instantly measured temperature and/or of a current instantly furnishable by the rechargeable battery.

39. The method as defined by claim 38, wherein a short-circuit current is varied as a function of the instantly measured temperature.
